(19) United States
(12) Patent Application Publication
(10) Pub. No.: US 2026/0331741 A1
(43) Pub. Date: Oct. 22, 2026

(54) BEND-TYPE PHASE SHIFT CIRCUIT AND DIGITAL PHASE SHIFTER

(71) Applicant: Fujikura Ltd., Tokyo (JP)

(72) Inventor: Yusuke Uemichi, Sakura-shi (JP)

(73) Assignee: Fujikura Ltd., Tokyo (JP)

(21) Appl. No.: 19/644,178

(22) Filed: Apr. 10, 2026

(30) Foreign Application Priority Data
Apr. 16, 2025 (JP) 2025-067321

(51) Int. Cl. H01P 1/18

(52) U.S. Cl. CPC H01P 1/184

(57) ABSTRACT

A bend-type phase shift circuit 20a includes a signal line 41, an inner line 42, a first ground conductor 43 including a first conductor 43a electrically connected to one end of the inner line 42 and a second conductor 43b which is provided on the other end side of the inner line 42 and of which one end portion is connected to one end portion of the first conductor 43a, an electronic switch 47a, 47b provided between the other end of the inner line 42 and the second conductor 43b. The signal line 41 and the inner line 42 are bent. The bend-type phase shift circuit 20a is set to a low-delay mode in which the electronic switch 47a, 47b is in a closed state or to a high-delay mode in which the electronic switch 47a, 47b is in an open state.

### BACKGROUND OF THE INVENTION

### Field of the Invention

The present invention relates to a bend-type phase shift circuit and a digital phase shifter.

Priority is claimed on Japanese Patent Application No. 2025-067321, filed Apr. 16, 2025, the content of which is incorporated herein by reference.

### Description of Related Art

In recent years, a digital control-type phase shifter (digital phase shifter) targeting high-frequency signals of microwaves, quasi-millimeter waves, millimeter waves, or the like has been developed. The digital phase shifter has a configuration in which a plurality of digital phase shift circuits, each of which is a unit, are cascade-connected. When the configuration of the digital phase shifter is a configuration in which the digital phase shift circuits are connected in a row, the length of the digital phase shifter increases.

Japanese Patent No. 7076658 discloses a digital phase shifter of which the length is decreased by adopting a configuration in which the digital phase shifter is bent by using a connection portion such as a bend-type line having a bent structure. Specifically, Japanese Patent No. 7076658 discloses a digital phase shifter having a bent configuration using a 180° bend-type connection portion and a digital phase shifter having a bent configuration using a 90° bend-type connection portion.

### SUMMARY OF THE INVENTION

In the digital phase shifter disclosed in Japanese Patent No. 7076658, when the number of digital phase shift circuits increases, the number of bending times increases, such that the length of the digital phase shifter is decreased as much as possible in many cases. For example, the digital phase shifter may have a zigzag shape (or a meandering shape) or a spiral shape. Here, the connection portion does not have a function as a phase shift circuit. Therefore, as the number of bending times increases, an occupied area of a portion that does not function as the phase shift circuit increases. As a result, the mounting area of the digital phase shifter increases.

The present invention is made in view of the above-described circumstances, and an object of the present invention is to provide a bend-type phase shift circuit and a digital phase shifter which can decrease the mounting area, compared to those in the related art.

In order to solve the above-described problem, a bend-type phase shift circuit (20, 20a, 20b) according to a first aspect of the present invention includes a signal line (41), an inner line (42) provided on at least one side of the signal line, a first ground conductor (43) including a first conductor (43a) electrically connected to one end of the inner line, and a second conductor (43b) which is provided on the other end side of the inner line and of which one end portion is connected to one end portion of the first conductor, and an electronic switch (47a, 47b) provided between the other end of the inner line and the second conductor. The signal line and the inner line are bent such that one end portion of the first conductor and one end portion of the second conductor included in the first ground conductor are disposed on an inner bent side with respect to the signal line and the inner line, and the bend-type phase shift circuit (20, 20a, 20b) is set to a low-delay mode in which the electronic switch is in a closed state or to a high-delay mode in which the electronic switch is in an open state.

The bend-type phase shift circuit according to the first aspect of the present invention includes the signal line, the inner line, the first ground conductor including the first conductor and the second conductor in which one end portion of the first conductor and one end portion of the second conductor are connected, and the electronic switch, and is set to the low-delay mode or the high-delay mode. In this manner, a mutual inductance between the signal line and the inner line is changed. In addition, the signal line and the inner line are bent. In this manner, in the bend-type phase shift circuit, a function of bending a signal path and a function as a phase shift circuit can be realized. Since this bend-type phase shift circuit is applied to a digital phase shifter, the mounting area can be decreased, compared to that in the related art.

As the bend-type phase shift circuit according to a second aspect of the present invention, the bend-type phase shift circuit according to the first aspect of the present invention may include a capacitor (45) electrically connected between the signal line and at least one of the first conductor and the second conductor included in the first ground conductor.

As the bend-type phase shift circuit according to a third aspect of the present invention, in the bend-type phase shift circuit according to the first or second aspect of the present invention, the first conductor and the second conductor included in the first ground conductor may be strip-shaped conductors disposed such that extending directions thereof intersect each other.

As the bend-type phase shift circuit according to a fourth aspect of the present invention, in the bend-type phase shift circuit according to any one of the first to third aspects of the present invention, the one end portion of the first conductor and the one end portion of the second conductor included in the first ground conductor may be in a state of protruding toward the signal line and the inner line in a plan view.

As the bend-type phase shift circuit according to a fifth aspect of the present invention, in the bend-type phase shift circuit according to any one of the first to third aspects of the present invention, the first ground conductor may include a third conductor (43c) connected to the one end portion of the first conductor and the one end portion of the second conductor and having a surface shape that protrudes toward the signal line and the inner line in a plan view.

As the bend-type phase shift circuit according to a sixth aspect of the present invention, the bend-type phase shift circuit according to any one of the first to fifth aspects of the present invention may include a second ground conductor (44) disposed on an outer bent side with respect to the signal line and the inner line, and connecting the other end portion of the first conductor and the other end portion of the second conductor included in the first ground conductor.

As the bend-type phase shift circuit according to a seventh aspect of the present invention, in the bend-type phase shift circuit according to the sixth aspect of the present invention, the second ground conductor may include a fourth conductor (44a) of which the other end portion is connected to the other end portion of the first conductor included in the first ground conductor, and a fifth conductor (44b) of which the other end portion is connected to the other end portion of the second conductor included in the first ground conductor and one end portion is connected to one end portion of the fourth conductor.

As the bend-type phase shift circuit according to an eighth aspect of the present invention, in the bend-type phase shift circuit according to the seventh aspect of the present invention, the fourth conductor and the fifth conductor included in the second ground conductor may be strip-shaped conductors disposed such that extending directions thereof intersect each other, and having a larger width than the first conductor and the second conductor included in the first ground conductor.

As the bend-type phase shift circuit according to a ninth aspect of the present invention, in the bend-type phase shift circuit according to the seventh or eighth aspect of the present invention, the second ground conductor may include a sixth conductor (44c) connected to the one end portion of the fourth conductor and the one end portion of the fifth conductor and having a surface shape that protrudes toward the signal line and the inner line in a plan view.

As the bend-type phase shift circuit according to a tenth aspect of the present invention, the bend-type phase shift circuit according to any one of the first to ninth aspects of the present invention may include an outer line (48) disposed on an outer bent side with respect to the signal line and the inner line and electrically connected to the other end portion of the first conductor and the other end portion of the second conductor included in the first ground conductor.

As the bend-type phase shift circuit according to an eleventh aspect of the present invention, in the bend-type phase shift circuit according to any one of the first to tenth aspects of the present invention, the first ground conductor may be formed by electrically connected multilayer conductive layers (CL).

As the bend-type phase shift circuit according to a twelfth aspect of the present invention, in the bend-type phase shift circuit according to any one of the sixth to ninth aspects of the present invention, the second ground conductor may be formed by the electrically connected multilayer conductive layers (CL).

A digital phase shifter (100, 200) according to a first aspect of the present invention includes a first digital phase shift circuit group (30) in which a plurality of digital phase shift circuits (10) are cascade-connected, a second digital phase shift circuit group (31) in which a plurality of digital phase shift circuits (10) are cascade-connected, and the bend-type phase shift circuit (20, 20a, 20b) according to any one of the first to twelfth aspects, which is configured to electrically connect a first digital phase shift circuit (10-5) located at one end portion of the first digital phase shift circuit group, and a second digital phase shift circuit (10-7) located at one end portion of the second digital phase shift circuit group.

A digital phase shifter (100) according to a second aspect of the present invention includes a first digital phase shift circuit group (30) in which a plurality of digital phase shift circuits (10) are cascade-connected, a second digital phase shift circuit group (31) in which the plurality of digital phase shift circuits (10) are cascade-connected, a third digital phase shift circuit (10-6) electrically connected to a first digital phase shift circuit (10-5) located at one end portion of the first digital phase shift circuit group and a second digital phase shift circuit (10-7) located at one end portion of the second digital phase shift circuit group, a first bend-type phase shift circuit (20a) that is the bend-type phase shift circuit according to any one of the first to twelfth aspects, which is configured to connect the first digital phase shift circuit and the third digital phase shift circuit, and a second bend-type phase shift circuit (20b) that is the bend-type phase shift circuit according to any one of the first to twelfth aspects, which is configured to connect the second digital phase shift circuit and the third digital phase shift circuit.

As the digital phase shifter according to a third aspect of the present invention, in the digital phase shifter according to the first aspect of the present invention, each of the plurality of digital phase shift circuits forming the first digital phase shift circuit group and the plurality of digital phase shift circuits forming the second digital phase shift circuit group may be a circuit that includes a signal line (1), a pair of inner lines (2) provided on both sides of the signal line, a pair of outer lines (3) provided on outer sides of the pair of inner lines, a first ground conductor (4a) electrically connected to one end of each of the pair of inner lines and the pair of outer lines, a second ground conductor (4b) electrically connected to the other end of each of the pair of outer lines, and a pair of electronic switches (7a, 7b) respectively provided between the other ends of the pair of inner lines and the second ground conductor, and that are set to a low-delay mode in which the pair of electronic switches are in a closed state or a high-delay mode in which the pair of electronic switches are in an open state.

As the digital phase shifter according to a fourth aspect of the present invention, in the digital phase shifter according to the second aspect of the present invention, each of the plurality of digital phase shift circuits forming the first digital phase shift circuit group, the plurality of digital phase shift circuits forming the second digital phase shift circuit group, and the third digital phase shift circuit may be a circuit that includes a signal line (1), a pair of inner lines (2) provided on both sides of the signal line, a pair of outer lines (3) provided on outer sides of the pair of inner lines, a first ground conductor (4a) electrically connected to one end of each of the pair of inner lines and the pair of outer lines, a second ground conductor (4b) electrically connected to the other end of each of the pair of outer lines, and a pair of electronic switches (7a, 7b) respectively provided between the other ends of the pair of inner lines and the second ground conductor, and that are set to a low-delay mode in which the pair of electronic switches are in a closed state or a high-delay mode in which the pair of electronic switches are in an open state.

According to the present invention, there is an advantageous effect that the mounting area of the digital phase shifter can be decreased, compared to that in the related art.

### BRIEF DESCRIPTION OF THE DRAWINGS

FIG. 1 is a plan view showing the schematic configuration of a digital phase shifter according to a first embodiment of the present invention.

FIG. 2 is a perspective view showing the configuration of a digital phase shift circuit in the first embodiment of the present invention.

FIG. 3 is a diagram showing a high-delay mode of the digital phase shift circuit in the first embodiment of the present invention.

FIG. 4 is a diagram showing a low-delay mode of the digital phase shift circuit in the first embodiment of the present invention.

FIG. 5 is a plan view showing the configuration of a bend-type phase shift circuit according to the first embodiment of the present invention.

FIG. 6 is a plan view showing the configuration of a bend-type phase shift circuit according to a first modification example in the first embodiment of the present invention.

FIG. 7 is a plan view showing the configuration of a bend-type phase shift circuit according to a second modification example in the first embodiment of the present invention.

FIG. 8 is a plan view showing the configuration of a bend-type phase shift circuit according to a third modification example in the first embodiment of the present invention.

FIG. 9 is a plan view showing the configuration of a bend-type phase shift circuit according to a fourth modification example in the first embodiment of the present invention.

FIG. 10 is a plan view showing the configuration of a bend-type phase shift circuit according to a fifth modification example in the first embodiment of the present invention.

FIG. 11 is a plan view showing the configuration of a bend-type phase shift circuit according to a sixth modification example in the first embodiment of the present invention.

FIG. 12 is a cross-sectional view showing a part of the schematic configuration of a bend-type phase shift circuit according to a seventh modification example in the first embodiment of the present invention.

FIG. 13 is a plan view showing the configuration of a bend-type phase shift circuit according to an eighth modification example in the first embodiment of the present invention.

FIG. 14 is a plan view showing the schematic configuration of a digital phase shifter according to a second embodiment of the present invention.

### DETAILED DESCRIPTION OF THE INVENTION

Hereinafter, a bend-type phase shift circuit and a digital phase shifter according to an embodiment of the present invention are described in detail with reference to the drawings.

### FIRST EMBODIMENT

### Digital Phase Shifter

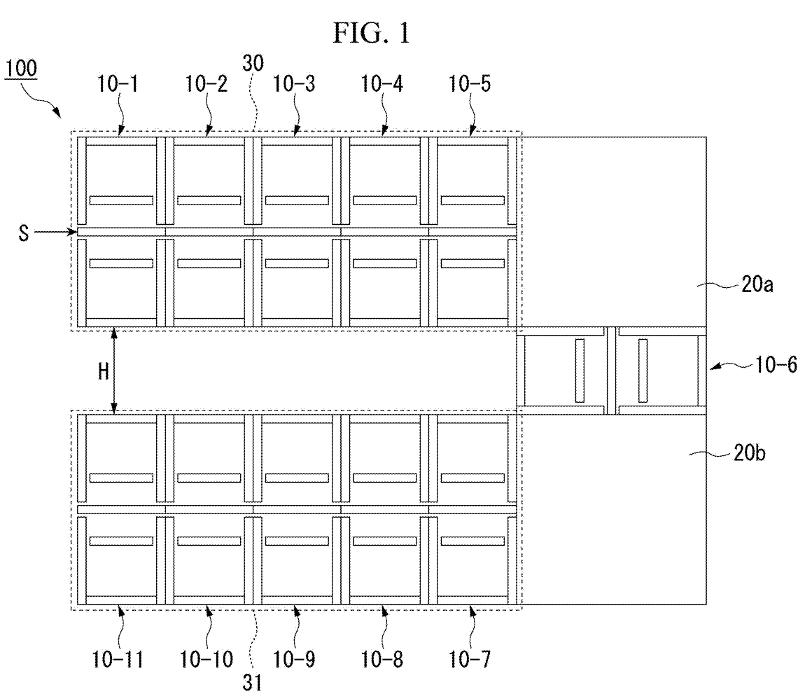

FIG. 1 is a plan view showing the schematic configuration of a digital phase shifter according to a first embodiment of the present invention. As shown in FIG. 1, a digital phase shifter 100 of the present embodiment includes a plurality of digital phase shift circuits 10 and a bend-type phase shift circuit 20a (first bend-type phase shift circuit) and a bend-type phase shift circuit 20b (second bend-type phase shift circuit). The digital phase shifter 100 shifts a phase of a signal S in a predetermined frequency band by using the plurality of digital phase shift circuits 10 and the bend-type phase shift circuits 20a and 20b that are cascade-connected. The signal S is a high-frequency signal having a frequency band of microwaves, quasi-millimeter waves, millimeter waves, or the like.

The plurality of digital phase shift circuits 10 are electrically cascade-connected. In an example shown in FIG. 1, eleven digital phase shift circuits 10 are electrically cascade-connected. However, the number of the digital phase shift circuits 10 is not limited to the example shown in FIG. 1, and may be three or more. In the example shown in FIG. 1, for convenience of description, the eleven digital phase shift circuits 10 that are electrically cascade-connected are denoted by digital phase shift circuits 10-1, 10-2, ..., and 10-11 in flowing order of the signal S. However, the flowing direction of the signal S may be reversed.

In the example shown in FIG. 1, the first to fifth digital phase shift circuits 10-1 to 10-5 that are cascade-connected form a first digital phase shift circuit group 30. In addition, the seventh to eleventh digital phase shift circuits 10-7 to 10-11 that are cascade-connected form a second digital phase shift circuit group 31. The sixth digital phase shift circuit 10-6 is located between the first digital phase shift circuit group 30 and the second digital phase shift circuit group 31, and is electrically connected to the first digital phase shift circuit group 30 and the second digital phase shift circuit group 31.

The bend-type phase shift circuits 20a and 20b have a shape of a 90° bend. The bend-type phase shift circuit 20a connects the digital phase shift circuit 10-5 (first digital phase shift circuit) located at one end portion of the first digital phase shift circuit group 30 and the other end portion of the digital phase shift circuit 10-6 (third digital phase shift circuit). The bend-type phase shift circuit 20b connects the digital phase shift circuit 10-7 (second digital phase shift circuit) located at one end portion of the second digital phase shift circuit group 31 and one end portion of the digital phase shift circuit 10-6 (third digital phase shift circuit). A specific configuration of the bend-type phase shift circuits 20a and 20b are described later.

The digital phase shifter 100 has a structure in which all of the plurality of digital phase shift circuits 10 are not aligned in a row, but a structure in which the digital phase shift circuits 10 are intermediately bent by the bend-type phase shift circuits 20a and 20b. For example, the first digital phase shift circuit group 30 and the second digital phase shift circuit group 31 are electrically connected by the bend-type phase shift circuits 20a and 20b. In this manner, the digital phase shifter 100 is bent. In this manner, the first digital phase shift circuit group 30 and the second digital phase shift circuit group 31 are disposed in parallel to be separated by a distance H.

### Digital Phase Shift Circuit

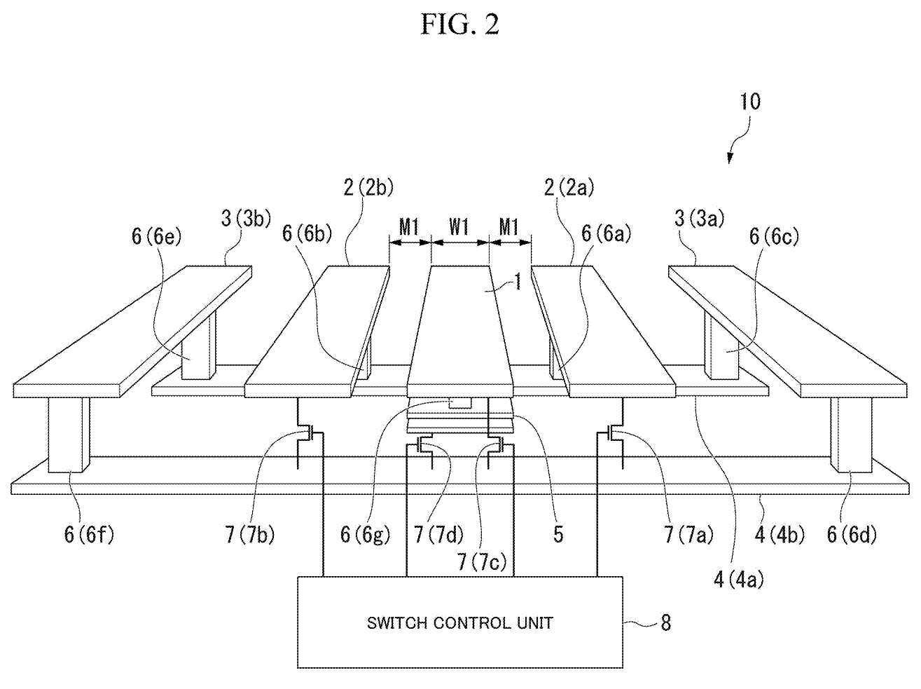

FIG. 2 is a perspective view showing a configuration of the digital phase shift circuit in the first embodiment of the present invention. As shown in FIG. 2, the digital phase shift circuit 10 includes a signal line 1, a pair of inner lines 2 (first inner line 2a and second inner line 2b), a pair of outer lines 3 (first outer line 3a and second outer line 3b), a pair of ground conductors 4 (first ground conductor 4a and second ground conductor 4b), a capacitor 5, a plurality of connection conductors 6, four electronic switches 7 (first electronic switch 7a, second electronic switch 7b, third electronic switch 7c, and fourth electronic switch 7d), and a switch control unit 8.

The signal line 1 is a linear strip-shaped conductor extending in a predetermined direction. That is, the signal line 1 is a long plate-shaped conductor having a constant width W1, a constant thickness, and a predetermined length. In an example shown in FIG. 2, the signal S flows from a front side toward a back side in the signal line 1.

The first inner line 2a is a linear strip-shaped conductor. That is, the first inner line 2a is a long plate-shaped conductor having a constant width, a constant thickness, and a predetermined length. The first inner line 2a extends in the same direction as an extending direction of the signal line 1. The first inner line 2a is provided in parallel with the signal line 1, and is separated to one side (right side in FIG. 2) of the signal line 1 by a predetermined distance M1.

The second inner line 2b is a linear strip-shaped conductor. That is, as in the first inner line 2a, the second inner line 2b is a long plate-shaped conductor having a constant width, a constant thickness, and a predetermined length. The second inner line 2b extends in the same direction as the extending direction of the signal line 1. The second inner line 2b is provided in parallel with the signal line 1, and is separated to the other side (left side in FIG. 2) of the signal line 1 by the predetermined distance M1.

The first outer line 3a is a linear strip-shaped conductor provided at a position farther from the signal line 1 than the first inner line 2a is, on one side of the signal line 1. The first outer line 3a is a long plate-shaped conductor having a constant width, a constant thickness, and a predetermined length. The first outer line 3a is provided in parallel with the signal line 1 to be separated at a predetermined distance from the signal line 1 in a state where the first inner line 2a is interposed therebetween. As in the first inner line 2a and the second inner line 2b, the first outer line 3a extends in the same direction as the extending direction of the signal line 1.

The second outer line 3b is a linear strip-shaped conductor provided at a position farther from the signal line 1 than the second inner line 2b is, on the other side of the signal line 1. As in the first outer line 3a, the second outer line 3b is a long plate-shaped conductor having a constant width, a constant thickness, and a predetermined length. The second outer line 3b is provided in parallel with the signal line 1 to be separated at a predetermined distance from the signal line 1 in a state where the second inner line 2b is interposed therebetween. As in the first inner line 2a and the second inner line 2b, the second outer line 3b extends in the same direction as the extending direction of the signal line 1.

The first ground conductor 4a is a linear strip-shaped conductor provided on one end side of each of the first inner line 2a, the second inner line 2b, the first outer line 3a, and the second outer line 3b. The first ground conductor 4a is electrically connected to one end of each of the first inner line 2a, the second inner line 2b, the first outer line 3a, and the second outer line 3b. The first ground conductor 4a is a long plate-shaped conductor having a constant width, a constant thickness, and a predetermined length.

The first ground conductor 4a is provided to be orthogonal to the first inner line 2a, the second inner line 2b, the first outer line 3a, and the second outer line 3b which extend in the same direction. The first ground conductor 4a is provided below to be separated at a predetermined distance from the first inner line 2a, the second inner line 2b, the first outer line 3a, and the second outer line 3b.

The first ground conductor 4a is set such that one end (right end in FIG. 2) thereof in a left-right direction is located at substantially the same position as a right side edge portion of the first outer line 3a in the left-right direction. In addition, the first ground conductor 4a is set such that the other end (left end in FIG. 2) thereof in the left-right direction is located at substantially the same position as a left side edge portion of the second outer line 3b in the left-right direction.

The second ground conductor 4b is a linear strip-shaped conductor provided on the other end side of each of the first inner line 2a, the second inner line 2b, the first outer line 3a, and the second outer line 3b. As in the first ground conductor 4a, the second ground conductor 4b is a long plate-shaped conductor having a constant width, a constant thickness, and a predetermined length.

The second ground conductor 4b is disposed in parallel with the first ground conductor 4a, and is provided to be orthogonal to the first inner line 2a, the second inner line 2b, the first outer line 3a, and the second outer line 3b, as in the first ground conductor 4a. The second ground conductor 4b is provided below to be separated at a predetermined distance from the first inner line 2a, the second inner line 2b, the first outer line 3a, and the second outer line 3b.

The second ground conductor 4b is set such that one end (right end in FIG. 2) thereof in the left-right direction is located at substantially the same position as the right side edge portion of the first outer line 3a in the left-right direction. In addition, the second ground conductor 4b is set such that the other end (left end in FIG. 2) thereof in the left-right direction is located at substantially the same position as the left side edge portion of the second outer line 3b in the left-right direction.

The capacitor 5 is provided between the other end of the signal line 1 and the second ground conductor 4b. For example, in the capacitor 5, an upper electrode thereof is electrically connected to the signal line 1, and a lower electrode thereof is electrically connected to the fourth electronic switch 7d. For example, the capacitor 5 is a thin film capacitor having a metal insulator metal (MIM) structure. The capacitor 5 has a capacitance Ca corresponding to a facing area of parallel flat plates. However, a comb tooth-type capacitor may be used for the capacitor 5 instead of a parallel flat plate capacitor.

The plurality of connection conductors 6 include at least connection conductors 6a to 6f. The connection conductor 6a is a conductor that electrically and mechanically connects one end of the first inner line 2a and the first ground conductor 4a. For example, the connection conductor 6a is a conductor extending in an up-down direction in which one end (upper end) thereof is connected to a lower surface of the first inner line 2a, and the other end (lower end) thereof is connected to an upper surface of the first ground conductor 4a.

The connection conductor 6b is a conductor that electrically and mechanically connects one end of the second inner line 2b and the first ground conductor 4a. For example, as in the connection conductor 6a, the connection conductor 6b is a conductor extending in the up-down direction in which one end (upper end) thereof is connected to the lower surface of the second inner line 2b, and the other end (lower end) thereof is connected to the upper surface of the first ground conductor 4a.

The connection conductor 6c is a conductor that electrically and mechanically connects one end of the first outer line 3a and the first ground conductor 4a. For example, the connection conductor 6c is a conductor extending in the up-down direction in which one end (upper end) thereof is connected to the lower surface of the first outer line 3a at one end of the first outer line 3a, and the other end (lower end) thereof is connected to the upper surface of the first ground conductor 4a.

The connection conductor 6d is a conductor that electrically and mechanically connects the other end of the first outer line 3a and the second ground conductor 4b. For example, the connection conductor 6d is a conductor extending in the up-down direction in which one end (upper end) thereof is connected to the lower surface of the first outer line 3a at the other end of the first outer line 3a, and the other end (lower end) thereof is connected to the upper surface of the second ground conductor 4b.

The connection conductor 6e is a conductor that electrically and mechanically connects one end of the second outer line 3b and the first ground conductor 4a. For example, the connection conductor 6e is a conductor extending in the up-down direction in which one end (upper end) thereof is connected to the lower surface of the second outer line 3b at one end of the second outer line 3b, and the other end (lower end) thereof is connected to the upper surface of the first ground conductor 4a.

The connection conductor 6f is a conductor that electrically and mechanically connects the other end of the second outer line 3b and the second ground conductor 4b. For example, the connection conductor 6f is a conductor extending in the up-down direction in which one end (upper end) thereof is connected to the lower surface of the second outer line 3b at the other end of the second outer line 3b, and the other end (lower end) thereof is connected to the upper surface of the second ground conductor 4b.

The connection conductor 6g is a conductor that electrically and mechanically connects the other end of the signal line 1 and the upper electrode of the capacitor 5. For example, the connection conductor 6g is a conductor extending in the up-down direction in which one end (upper end) thereof is connected to the lower surface of the signal line 1 at the other end of the signal line 1, and the other end (lower end) thereof is connected to the upper electrode of the capacitor 5.

The first electronic switch 7a is located between the other end of the first inner line 2a and the second ground conductor 4b, and is electrically connected to the other end of the first inner line 2a and the second ground conductor 4b. For example, the first electronic switch 7a is a MOS-type FET (field effect transistor) in which a drain terminal thereof is electrically connected to the other end of the first inner line 2a, a source terminal thereof is electrically connected to the second ground conductor 4b, and a gate terminal thereof is electrically connected to the switch control unit 8.

The first electronic switch 7a is controlled to be in a closed state or in an open state, based on a gate signal input to the gate terminal of the first electronic switch 7a from the switch control unit 8. The closed state of the electronic switch is a state where the drain terminal and the source terminal thereof are respectively conductive. The open state of the electronic switch is a state where the drain terminal and the source terminal thereof are not respectively conductive, and the electrical connection of the electronic switch is cut off. Under the control of the switch control unit 8, the first electronic switch 7a is brought into a conductive state where the other end of the first inner line 2a and the second ground conductor 4b are electrically connected or into a cutoff state where the electrical connection therebetween is cut off.

The second electronic switch 7b is located between the other end of the second inner line 2b and the second ground conductor 4b, and is electrically connected to the other end of the second inner line 2b and the second ground conductor 4b. For example, the second electronic switch 7b is the MOS-type FET in which the drain terminal thereof is connected to the other end of the second inner line 2b, the source terminal thereof is connected to the second ground conductor 4b, and the gate terminal thereof is connected to the switch control unit 8.

The second electronic switch 7b is controlled to be in the closed state or in the open state, based on a gate signal input to the gate terminal of the second electronic switch 7b from the switch control unit 8. Under the control of the switch control unit 8, the second electronic switch 7b is brought into a conductive state where the other end of the second inner line 2b and the second ground conductor 4b are electrically connected or into a cutoff state where the electrical connection therebetween is cut off.

The third electronic switch 7c is located between the other end of the signal line 1 and the second ground conductor 4b, and is electrically connected to the other end of the signal line 1 and the second ground conductor 4b. For example, the third electronic switch 7c is the MOS-type FET in which the drain terminal thereof is connected to the other end of the signal line 1, the source terminal thereof is connected to the second ground conductor 4b, and the gate terminal thereof is connected to the switch control unit 8. In the example shown in FIG. 2, the third electronic switch 7c is provided on the other end side of the signal line 1, but the present invention is not limited thereto. The third electronic switch 7c may be provided on one end side of the signal line 1. The third electronic switch 7c may not be used unless necessary.

The third electronic switch 7c is controlled to be in the closed state or in the open state, based on a gate signal input to the gate terminal of the third electronic switch 7c from the switch control unit 8. Under the control of the switch control unit 8, the third electronic switch 7c is brought into a conductive state where the other end of the signal line 1 and the second ground conductor 4b are electrically connected or into a cutoff state where the electrical connection therebetween is cut off.

The fourth electronic switch 7d is connected in series to the capacitor 5 between the other end of the signal line 1 and the second ground conductor 4b. For example, the fourth electronic switch 7d is the MOS-type FET. In the example shown in FIG. 2, in the fourth electronic switch 7d, the drain terminal thereof is connected to the lower electrode of the capacitor 5, the source terminal thereof is connected to the second ground conductor 4b, and the gate terminal thereof is connected to the switch control unit 8.

The fourth electronic switch 7d is controlled to be in the closed state or in the open state, based on a gate signal input to the gate terminal of the fourth electronic switch 7d from the switch control unit 8. Under the control of the switch control unit 8, the fourth electronic switch 7d is brought into a conductive state where the lower electrode of the capacitor 5 and the second ground conductor 4b are electrically connected or into a cutoff state where the electrical connection therebetween is cut off.

The switch control unit 8 is a control circuit that controls the first electronic switch 7a, the second electronic switch 7b, the third electronic switch 7c, and the fourth electronic switch 7d, which are the plurality of electronic switches 7. For example, the switch control unit 8 includes four output ports. The switch control unit 8 outputs gate signals from the output ports thereof respectively, and supplies the gate signals to the gate terminals of the plurality of electronic switches 7 respectively. In this manner, the switch control unit 8 controls the plurality of electronic switches 7 to be in the open state or the closed state respectively.

FIG. 2 shows a perspective schematic view of the digital phase shift circuit 10 to easily understand a mechanical structure of the digital phase shift circuit 10, but the actual digital phase shift circuit 10 is formed as a multilayer structure by using a semiconductor manufacturing technology.

For example, in the digital phase shift circuit 10, the signal line 1, the first inner line 2a, the second inner line 2b, the first outer line 3a, and the second outer line 3b are formed in a first conductive layer. The first ground conductor 4a and the second ground conductor 4b are formed in a second conductive layer facing the first conductive layer with an insulating layer interposed therebetween. Components formed in the first conductive layer and components formed in the second conductive layer are connected to each other through via holes. The plurality of connection conductors 6 correspond to via holes embedded into the insulating layer.

Next, an operation of the digital phase shift circuit 10 in the present embodiment is described. Operation modes of the digital phase shift circuit 10 include a high-delay mode and a low-delay mode. The digital phase shift circuit 10 is operated in the high-delay mode or the low-delay mode.

### High-Delay Mode

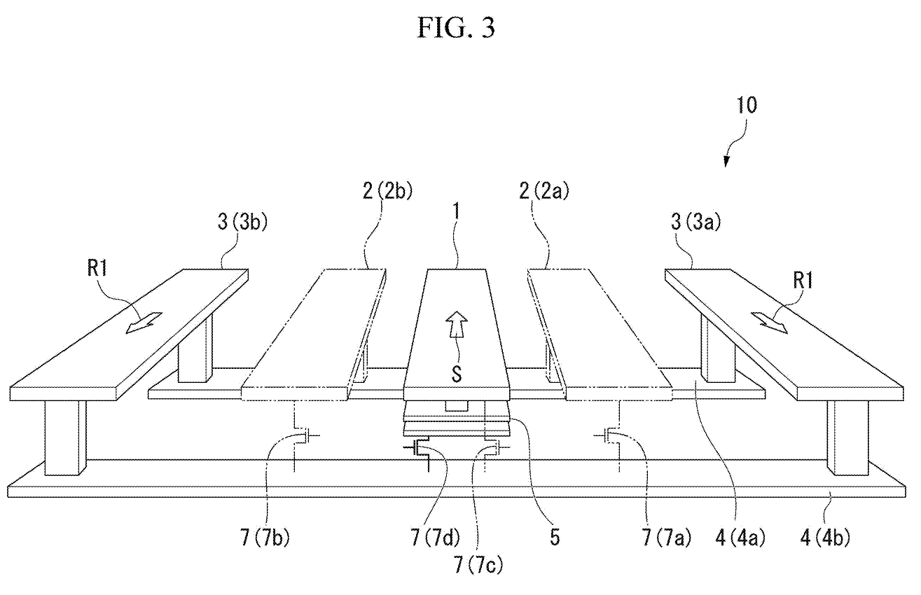

FIG. 3 is a diagram showing the high-delay mode of the digital phase shift circuit according to the first embodiment of the present invention. The high-delay mode is a mode in which a first passing phase is generated in the signal S. In the high-delay mode, as shown in FIG. 3, the first electronic switch 7a and the second electronic switch 7b are controlled to be in an open state, and the fourth electronic switch 7d is controlled to be in a closed state.

The first electronic switch 7a is controlled to be in the open state, thereby causing a state where the electrical connection between the other end of the first inner line 2a and the second ground conductor 4b is cut off. The second electronic switch 7b is controlled to be in the open state, thereby causing a state where the electrical connection between the other end of the second inner line 2b and the second ground conductor 4b is cut off. The fourth electronic switch 7d is controlled to be in the closed state, thereby causing a state where the other end of the signal line 1 is electrically connected to the second ground conductor 4b via the capacitor 5.

When the signal S propagates from an input end (the other end) toward an output end (one end) in the signal line 1, a return current R1 flows toward the other end from the one end in a direction opposite to a flowing direction of the signal S. In the high-delay mode, since the first electronic switch 7a and the second electronic switch 7b are in the open state, the return current R1 mainly flows through the first outer line 3a and the second outer line 3b as shown in FIG. 3.

In the high-delay mode, since the return current R1 flows through the first outer line 3a and the second outer line 3b, an inductance value L is greater than that in the low-delay mode. In the high-delay mode, a larger delay amount can be obtained than that in the low-delay mode. In addition, in the high-delay mode, when the fourth electronic switch 7d is in the closed state, the other end of the signal line 1 and the second ground conductor 4b are electrically connected by the capacitor 5. Therefore, a capacitance value C of the digital phase shift circuit 10 in the high-delay mode is also greater than that in the low-delay mode. Therefore, in the high-delay mode, a larger delay amount can be obtained than that in the low-delay mode.

### Low-Delay Mode

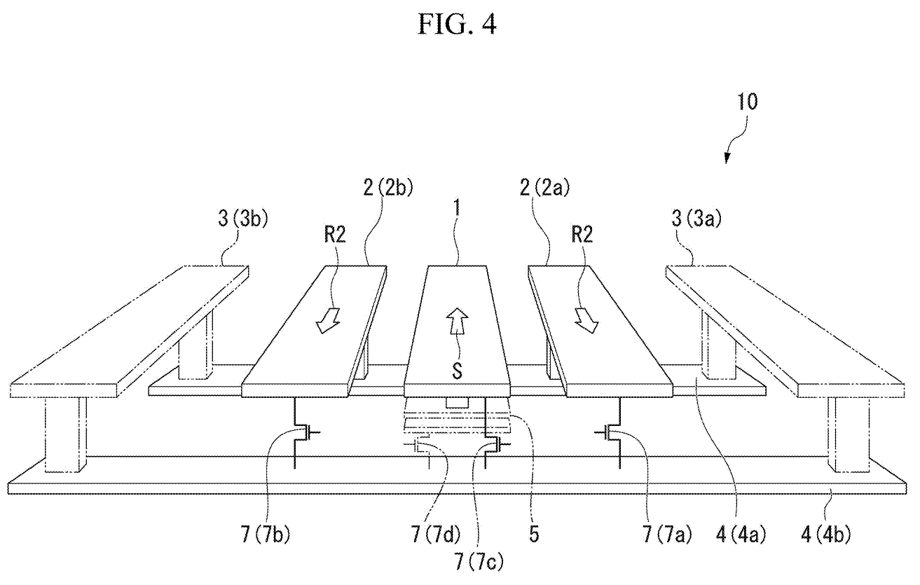

FIG. 4 is a diagram showing the low-delay mode of the digital phase shift circuit according to the first embodiment of the present invention. The low-delay mode is a mode in which a second passing phase smaller than the first passing phase is generated in the signal S. In the low-delay mode, as shown in FIG. 4, the first electronic switch 7a and the second electronic switch 7b are controlled to be in the closed state, and the fourth electronic switch 7d is controlled to be in the open state.

The first electronic switch 7a is controlled to be in the closed state, thereby causing a state where the other end of the first inner line 2a and the second ground conductor 4b are electrically connected. The second electronic switch 7b is controlled to be in the closed state, thereby causing a state where the other end of the second inner line 2b and the second ground conductor 4b are electrically connected.

When the signal S propagates from the input end (the other end) toward the output end (one end) in the signal line 1, a return current R2 flows toward the other end from the one end in a direction opposite to the flowing direction of the signal S. In the low-delay mode, since the first electronic switch 7a and the second electronic switch 7b are in the closed state, the return current R2 mainly flows through the first inner line 2a and the second inner line 2b as shown in FIG. 4.

In the low-delay mode, since the return current R2 flows through the first inner line 2a and the second inner line 2b, the inductance value L is smaller than that in the high-delay mode. The delay amount in the low-delay mode is smaller than the delay amount in the high-delay mode. In addition, although the capacitor 5 is connected to the other end of the signal line 1, the fourth electronic switch 7d is in the open state. Therefore, the capacitance of the capacitor 5 does not function, and only a parasitic capacitance that is extremely smaller compared to the capacitance of the capacitor 5 is present. Therefore, in the low-delay mode, a smaller delay amount can be obtained, compared to that in the high-delay mode.

Here, in the low-delay mode, since the third electronic switch 7c is controlled to be in the closed state, a loss of the signal line 1 can be intentionally increased. Thus, the loss of a high-frequency signal in the low-delay mode can be set to be approximately the same as the loss of a high-frequency signal in the high-delay mode.

That is, in some cases, the loss of the high-frequency signal in the low-delay mode may be smaller than the loss of the high-frequency signal in the high-delay mode. This loss difference causes an amplitude difference of the high-frequency signal output from the digital phase shift circuit 10, when the operation mode is switched between the low-delay mode and the high-delay mode. In response to these circumstances, the digital phase shift circuit 10 may eliminate the amplitude difference by controlling the third electronic switch 7c to be in the closed state in the low-delay mode. Depending on the design, the loss of the high-frequency signal in the low-delay mode may be greater than the loss of the high-frequency signal in the high-delay mode.

### Bend-Type Phase Shift Circuit

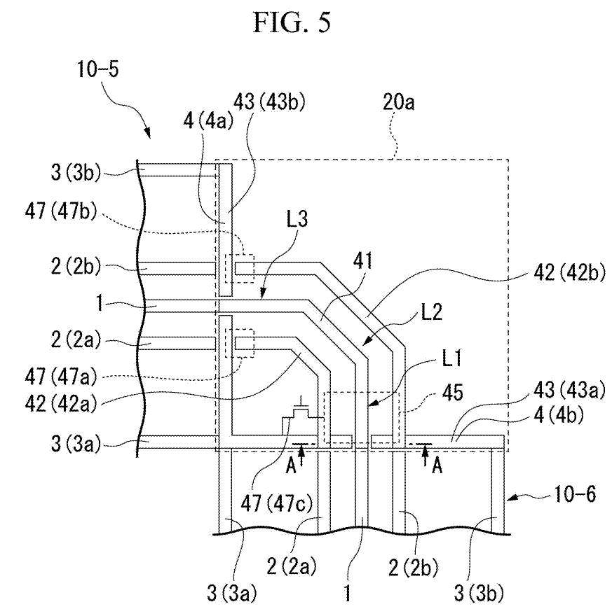

FIG. 5 is a plan view showing a configuration of the bend-type phase shift circuit according to the first embodiment of the present invention. The digital phase shifter 100 of the present embodiment includes the bend-type phase shift circuits 20a and 20b. However, since the bend-type phase shift circuits 20a and 20b have the same configuration, the bend-type phase shift circuit 20a is described here, and the bend-type phase shift circuit 20b is omitted in the description.

As shown in FIG. 5, the bend-type phase shift circuit 20a includes a signal line 41, a pair of inner lines 42 (first inner line 42a and second inner line 42b), a first ground conductor 43, a capacitor 45, and three electronic switches 47 (first electronic switch 47a, second electronic switch 47b, and third electronic switch 47c).

The signal line 41 corresponds to the signal line 1 shown in FIG. 2, and the signal S flows through the signal line 41. The pair of inner lines 42 (first inner line 42a and second inner line 42b) correspond to the pair of inner lines 2 (first inner line 2a and second inner line 2b) shown in FIG. 2, and a current corresponding to the return current R2 shown in FIG. 4 flows through the pair of inner lines 42.

As shown in the drawing, the signal line 41 and the pair of inner lines 42 (first inner line 42a and second inner line 42b) are bent. Specifically, the signal line 41 and the pair of inner lines 42 are bent such that the first inner line 42a is disposed on an inner bent side with respect to the signal line 41, and the second inner line 42b is disposed on an outer bent side with respect to the signal line 41.

In the example shown in FIG. 5, each of the signal line 41 and the pair of inner lines 42 is bent at two locations, and includes three straight portions. For example, the signal line 41 includes a first straight portion L1 extending in a direction along the signal line 1 of the digital phase shift circuit 10-6, a second straight portion L2 extending in an oblique direction with respect to the direction along the signal line 1 of the digital phase shift circuit 10-6, and a third straight portion L3 extending in a direction along the signal line 1 of the digital phase shift circuit 10-5. Each of the pair of inner lines 42 also includes the first straight portion L1, the second straight portion L2, and the third straight portion L3.

One end of the signal line 41 is connected to the other end of the signal line 1 of the digital phase shift circuit 10-6, and the other end of the signal line 41 is connected to one end of the signal line 1 of the digital phase shift circuit 10-5. One end of each of the pair of inner lines 42 is disposed to face the other end of each of the pair of inner lines 2 of the digital phase shift circuit 10-6, and is electrically connected to the first conductor 43a forming a part of the first ground conductor 43. The other end of each of the pair of inner lines 42 is disposed to face one end of each of the pair of inner lines 2 of the digital phase shift circuit 10-5.

The first ground conductor 43 corresponds to the pair of ground conductors 4 (first ground conductor 4a and second ground conductor 4b) shown in FIG. 2. That is, the first ground conductor 43 includes a first conductor 43a corresponding to the first ground conductor 4a shown in FIG. 2 and a second conductor 43b corresponding to the second ground conductor 4b. As described above, the first conductor 43a is electrically connected to one end of each of the pair of inner lines 42, and the second conductor 43b is provided on the other end side of the pair of inner lines 42.

The first conductor 43a is a strip-shaped conductor extending in a direction orthogonal to the signal line 1 of the digital phase shift circuit 10-6. The second conductor 43b is a strip-shaped conductor extending in a direction orthogonal to the signal line 1 of the digital phase shift circuit 10-5. That is, the first conductor 43a and the second conductor 43b are strip-shaped conductors disposed such that the extending directions thereof intersect (for example, are orthogonal to) each other.

The first conductor 43a and the second conductor 43b are physically directly connected to each other. Specifically, one end (one end portion) of the first conductor 43a and one end (one end portion) of the second conductor 43b are physically directly connected to each other, and a shape of the first ground conductor 43 in a plan view is an L-shape. The bend-type phase shift circuit 20a has a configuration in which the signal line 41 and the pair of inner lines 42 are bent such that the one end portion of the first conductor 43a and the one end portion of the second conductor 43b each included in the first ground conductor 43 are disposed on an inner bent side with respect to the signal line 41 and the pair of inner lines 42.

The first conductor 43a of the first ground conductor 43 is set such that one end (left end in FIG. 5) thereof in the left-right direction on the paper surface is located at substantially the same position as the left side edge portion of the first outer line 3a of the digital phase shift circuit 10-6 in the left-right direction on the paper surface. In addition, the first conductor 43a of the first ground conductor 43 is set such that the other end (right end in FIG. 5) thereof in the left-right direction on the paper surface is located at substantially the same position as the right side edge portion of the second outer line 3b of the digital phase shift circuit 10-6 in the left-right direction on the paper surface.

The second conductor 43b of the first ground conductor 43 is set such that one end (lower end in FIG. 5) thereof in the up-down direction on the paper surface is located at substantially the same position as the lower side edge portion of the first outer line 3a of the digital phase shift circuit 10-5 in the up-down direction on the paper surface. In addition, the second conductor 43b of the first ground conductor 43 is set such that the other end (upper end in FIG. 5) thereof in the up-down direction on the paper surface is located at substantially the same position as the upper side edge portion of the second outer line 3b of the digital phase shift circuit 10-5 in the up-down direction on the paper surface.

As an example, FIG. 5 shows a configuration in which the second conductor 43b of the first ground conductor 43 in the bend-type phase shift circuit 20a is shared with the first ground conductor 4a of the digital phase shift circuit 10-5, and the first conductor 43a of the first ground conductor 43 in the bend-type phase shift circuit 20a is shared with the second ground conductor 4b of the digital phase shift circuit 10-6. However, the second conductor 43b of the first ground conductor 43 in the bend-type phase shift circuit 20a and the first ground conductor 4a of the digital phase shift circuit 10-5 may not be shared with each other, and the first conductor 43a of the first ground conductor 43 in the bend-type phase shift circuit 20a and the second ground conductor 4b of the digital phase shift circuit 10-6 may not be shared with each other.

The capacitor 45 corresponds to the capacitor 5 shown in FIG. 2, and is provided between one end of the signal line 41 and the first conductor 43a of the first ground conductor 43. For example, in the capacitor 45, the upper electrode thereof is electrically connected to the signal line 41, and the lower electrode thereof is electrically connected to the third electronic switch 47c.

The three electronic switches 47 (first electronic switch 47a, second electronic switch 47b, and third electronic switch 47c) correspond to the three electronic switches 7 (first electronic switch 7a, second electronic switch 7b, and fourth electronic switch 7d) shown in FIG. 2. As in the three electronic switches 7 shown in FIG. 2, the three electronic switches 47 are controlled by the switch control unit 8.

The first electronic switch 47a is located between the other end of the first inner line 42a and the second conductor 43b of the first ground conductor 43, and is electrically connected to the other end of the first inner line 42a and the second conductor 43b of the first ground conductor 43. Under the control of the switch control unit 8, the first electronic switch 47a is brought into a conductive state where the other end of the first inner line 42a and the second conductor 43b of the first ground conductor 43 are electrically connected or into a cutoff state where the electrical connection therebetween is cut off.

The second electronic switch 47b is located between the other end of the second inner line 42b and the second conductor 43b of the first ground conductor 43, and is electrically connected to the other end of the second inner line 42b and the second conductor 43b of the first ground conductor 43. Under the control of the switch control unit 8, the second electronic switch 47b is brought into a conductive state where the other end of the second inner line 42b and the second conductor 43b of the first ground conductor 43 are electrically connected or into a cutoff state where the electrical connection therebetween is cut off.

The third electronic switch 47c is connected in series to the capacitor 45 between one end of the signal line 41 and the first conductor 43a of the first ground conductor 43. Under the control of the switch control unit 8, the third electronic switch 47c is brought into a conductive state where the lower electrode of the capacitor 45 and the first conductor 43a of the first ground conductor 43 are electrically connected or into a cutoff state where the electrical connection therebetween is cut off.

As an example, FIG. 5 shows a configuration in which the capacitor 45 and the third electronic switch 47c are provided on the digital phase shift circuit 10-6 side, and the capacitor 45 is electrically connected between one end of the signal line 41 and the first conductor 43a of the first ground conductor 43. However, a configuration may be adopted in which the capacitor 45 and the third electronic switch 47c are provided on the digital phase shift circuit 10-5 side, and the capacitor 45 is electrically connected between the other end of the signal line 41 and the second conductor 43b of the first ground conductor 43.

As in the digital phase shift circuit 10 shown in FIG. 2, operation modes of the bend-type phase shift circuit 20a formed in this way includes the high-delay mode and the low-delay mode, and the bend-type phase shift circuit 20a is operated in the high-delay mode or in the low-delay mode. That is, the bend-type phase shift circuit 20a is operated in the high-delay mode when the first electronic switch 47a and the second electronic switch 47b shown in FIG. 5 are controlled to be in the open state and the third electronic switch 47c is controlled to be in the closed state. When the bend-type phase shift circuit 20a is operated in the high-delay mode, a current corresponding to the return current R1 shown in FIG. 3 flows through the first ground conductor 43.

In addition, the bend-type phase shift circuit 20a is operated in the low-delay mode when the first electronic switch 47a and the second electronic switch 47b shown in FIG. 5 are controlled to be in the closed state and the third electronic switch 47c is controlled to be in the open state. When the bend-type phase shift circuit 20a is operated in the low-delay mode, a current corresponding to the return current R2 shown in FIG. 4 flows through the pair of inner lines 42.

In the bend-type phase shift circuit 20a, a mutual inductance between the signal line 41 and the pair of inner lines 42 when the first electronic switch 47a and the second electronic switch 47b shown in FIG. 5 are in the open state and a mutual inductance between the signal line 41 and the pair of inner lines 42 when the first electronic switch 47a and the second electronic switch 47b are in the closed state are different from each other. In addition, since the third electronic switch 47c is brought into the closed state or the open state, the capacitor 45 between the one end of the signal line 41 and the first conductor 43a of the first ground conductor 43 can be supplementarily valid or invalid. In this manner, the bend-type phase shift circuit 20a is operated as the phase shift circuit.

In the present embodiment, so to speak, the bend-type phase shift circuits 20a and 20b correspond to circuits in which the digital phase shift circuit 10 shown in FIG. 2 is bent by 90°, the pair of outer lines 3 are omitted, and the first ground conductor 4a and the second ground conductor 4b are integrated. Therefore, without significantly increasing the mounting area, a function of bending the path of the signal S by 90° and a function as a phase shifter can be realized.

### Operation of Digital Phase Shifter

The digital phase shifter 100 can realize various types of delays (amount of phase shift) by setting the operation modes of the digital phase shift circuits 10 and the bend-type phase shift circuits 20a and 20b which form the digital phase shifter 100 to the high-delay mode or the low-delay mode. For example, the operation of the digital phase shifter 100 includes two operations described below.

### First Operation

The first operation is an operation in which all of the digital phase shift circuits 10 and the bend-type phase shift circuits 20a and 20b are sequentially switched to the low-delay mode from a state where all of the digital phase shift circuits 10 and the bend-type phase shift circuits 20a and 20b are in the high-delay mode, in a connection order of the digital phase shift circuits 10 and the bend-type phase shift circuits 20a and 20b from the digital phase shift circuit 10-1 to the digital phase shift circuit 10-11. That is, in the first operation, the digital phase shift circuits 10-1 to 10-5, the bend-type phase shift circuit 20a, the digital phase shift circuit 10-6, the bend-type phase shift circuit 20b, and the digital phase shift circuits 10-7 to 10-11 are sequentially switched to the low-delay mode from the high-delay mode in this order.

### Second Operation

The second operation is an operation in which all of the digital phase shift circuits 10 and the bend-type phase shift circuits 20a and 20b are sequentially switched to the high-delay mode from a state where all of the digital phase shift circuits 10 and the bend-type phase shift circuits 20a and 20b are in the low-delay mode, in a connection order of the digital phase shift circuits 10 and the bend-type phase shift circuits 20a and 20b from the digital phase shift circuit 10-1 to the digital phase shift circuit 10-11. That is, in the second operation, the digital phase shift circuits 10-1 to 10-5, the bend-type phase shift circuit 20a, the digital phase shift circuit 10-6, the bend-type phase shift circuit 20b, and the digital phase shift circuits 10-7 to 10-11 are sequentially switched to the high-delay mode from the low-delay mode in this order.

As described above, the bend-type phase shift circuits 20a and 20b of the present embodiment include the signal line 41, the pair of inner lines 42 provided on both sides of the signal line 41, the first ground conductor 43 including the first conductor 43a electrically connected to one end of each of the pair of inner lines 42 and the second conductor 43b which is provided on the other end side of the pair of inner lines 42 and of which one end portion is electrically connected to one end portion of the first conductor 43a, and the pair of electronic switches 47a and 47b respectively provided between the other end of each of the pair of inner lines 42 and the second conductor 43b. The signal line 41 and the pair of inner lines 42 are bent such that one end portion of the first conductor 43a and one end portion of the second conductor 43b included in the first ground conductor 43 are disposed on an inner bent side with respect to the signal line 41 and the pair of inner lines 42, and the bend-type phase shift circuits 20a and 20b are set to the low-delay mode in which the pair of electronic switches 47a and 47b are in the closed state or to the high-delay mode in which the pair of electronic switches 47a and 47b are in the open state. In this manner, the bend-type phase shift circuits 20a and 20b in which a function as the phase shift circuit is added to a function of bending the path of the signal S by 90° which is a function of the connection portion in the related art can be realized.

Since the bend-type phase shift circuits 20a and 20b have the function of bending the path of the signal S by 90° and the function as the phase shift circuit, even when the number of bending times of the digital phase shifter 100 increases, an occupied area of a portion that does not function as the phase shifter does not increase. As a result, the mounting area of the digital phase shifter can be decreased, compared to that in the related art.

### Modification Example

Hereinafter, modification examples of the bend-type phase shift circuit according to the first embodiment of the present invention are described. In the drawings used in the following description, the same reference numerals are assigned to the configurations corresponding to the configurations shown in FIG. 5. In addition, in the following description as well, the bend-type phase shift circuit 20a is described, and the bend-type phase shift circuit 20b is omitted in the description.

### First Modification Example

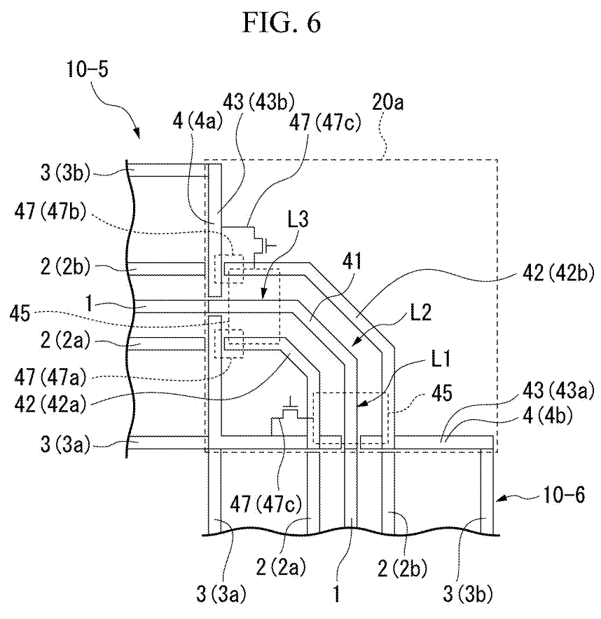

FIG. 6 is a plan view showing the configuration of a bend-type phase shift circuit according to a first modification example in the first embodiment of the present invention. As shown in FIG. 6, in a bend-type phase shift circuit 20a of the present modification example, the capacitor 45 and the third electronic switch 47c are also provided on the digital phase shift circuit 10-5 side as compared to the bend-type phase shift circuit 20a shown in FIG. 5.

The capacitor 45 provided on the digital phase shift circuit 10-5 side is provided between the other end of the signal line 41 and the second conductor 43b of the first ground conductor 43. For example, in the capacitor 45 provided on the digital phase shift circuit 10-5 side, the upper electrode thereof is electrically connected to the signal line 41, and the lower electrode thereof is electrically connected to the third electronic switch 47c provided on the digital phase shift circuit 10-5 side.

The third electronic switch 47c provided on the digital phase shift circuit 10-5 side is connected in series to the capacitor 45 provided on the digital phase shift circuit 10-5 side between the other end of the signal line 41 and the second conductor 43b of the first ground conductor 43. Under the control of the switch control unit 8, the third electronic switch 47c provided on the digital phase shift circuit 10-5 side is brought into a conductive state where the lower electrode of the capacitor 45 provided on the digital phase shift circuit 10-5 side and the second conductor 43b of the first ground conductor 43 are electrically connected or into a cutoff state where the electrical connection therebetween is cut off.

Since the capacitor 45 and the third electronic switch 47c are provided on the digital phase shift circuit 10-5 side and the digital phase shift circuit 10-6 side, the bend-type phase shift circuit 20a can be symmetrical. In this manner, characteristics of the bend-type phase shift circuit 20a when viewed from the digital phase shift circuit 10-5 side and characteristics of the bend-type phase shift circuit 20a when viewed from the digital phase shift circuit 10-6 side can coincide with each other (or can have the same characteristics).

### Second Modification Example

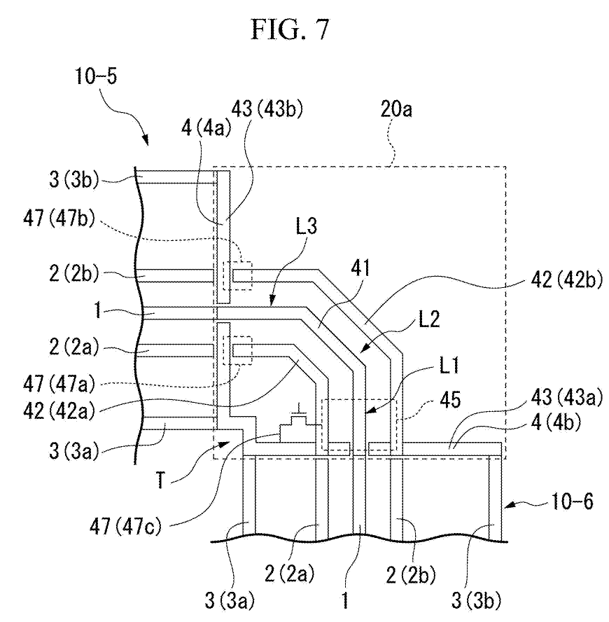

FIG. 7 is a plan view showing the configuration of a bend-type phase shift circuit according to a second modification example in the first embodiment of the present invention. As shown in FIG. 7, in the bend-type phase shift circuit 20a of the present modification example, as compared to the bend-type phase shift circuit 20a shown in FIG. 5, one end portion of the first conductor 43a and one end portion of the second conductor 43b included in the first ground conductor 43 (the portions indicated by a reference numeral T in FIG. 7) are in a state of protruding toward the signal line 41 and the pair of inner lines 42 in a plan view.

Specifically, one end portion of the first conductor 43a is bent by 90° to extend in a direction along the signal line 1 of the digital phase shift circuit 10-6. One end portion of the second conductor 43b is bent by 90° to extend in the direction along a signal line 1 of the digital phase shift circuit 10-5. A tip of one end portion of the bent first conductor 43a and a tip of one end portion of the bent second conductor 43b are connected. As shown in FIG. 7, it can be described that the first ground conductor 43 is bent in a W-shape or an M-shape in a plan view.

Since the first ground conductor 43 is brought into this state (shape), it is possible to increase the inductance of the first ground conductor 43 and to increase the amount of phase shift of the bend-type phase shift circuit 20a. An interval between the first inner line 2a and the first outer line 3a of each of the digital phase shift circuits 10-5 and 10-6 is narrowed as the first ground conductor 43 is brought into the state (shape) shown in FIG. 7.

As a shape that protrudes toward the signal line 41 and the pair of inner lines 42 in a plan view, one end portion (in FIG. 7, a portion indicated by a reference numeral T) of the first conductor 43a and the second conductor 43b included in the first ground conductor 43 may have any shape. For example, a shape that protrudes in an arc shape in a plan view may be adopted. For example, the protruding shape can be appropriately set in view of the magnitude of the inductance of the first ground conductor 43, the magnitude of the amount of phase shift of the bend-type phase shift circuit 20a, and the like.

### Third Modification Example

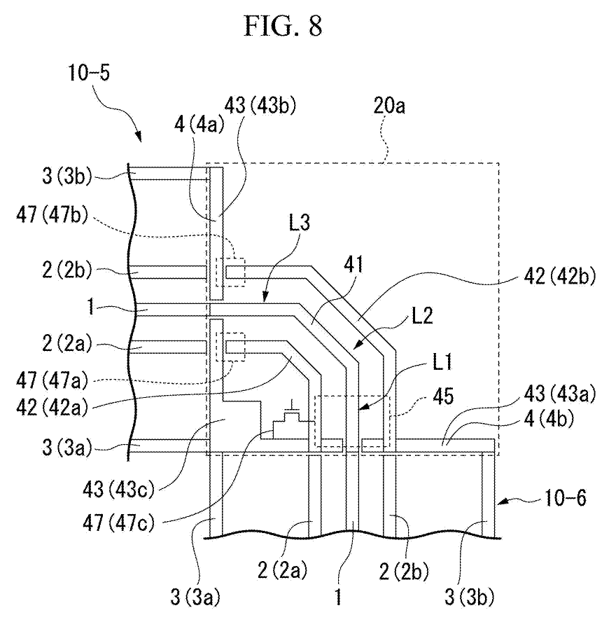

FIG. 8 is a plan view showing the configuration of a bend-type phase shift circuit according to a third modification example in the first embodiment of the present invention. As shown in FIG. 8, in the bend-type phase shift circuit 20a of the present modification example, the third conductor 43c is added to the first ground conductor 43, as compared to the bend-type phase shift circuit 20a shown in FIG. 5. Since the third conductor 43c is provided in the first ground conductor 43, it is possible to reduce the amount of phase shift of the bend-type phase shift circuit 20a by reducing the inductance of the first ground conductor 43.

The third conductor 43c is a conductor connected to one end portion of the first conductor 43a and one end portion of the second conductor 43b and having a surface shape that protrudes toward the signal line 41 and the pair of inner lines 42 in a plan view. The third conductor 43c shown in FIG. 8 has a rectangular shape in a plan view, but the third conductor 43c may have any shape in a plan view.

Here, when a protruding amount of the third conductor 43c is increased, the inductance of the first ground conductor 43 can be reduced. However, as the third conductor 43c is closer to the signal line 41, the influence of the mutual inductance between the first ground conductor 43 and the signal line 41 increases. Therefore, it is desirable that the protruding amount of the third conductor 43c is set in view of the magnitude of the inductance of the first ground conductor 43 and the influence of the mutual inductance between the first ground conductor 43 and the signal line 41.

### Fourth Modification Example

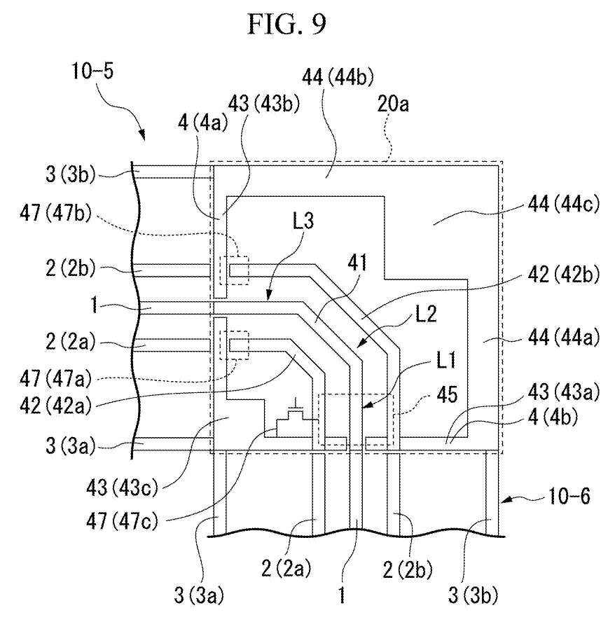

FIG. 9 is a plan view showing the configuration of a bend-type phase shift circuit according to a fourth modification example in the first embodiment of the present invention. As shown in FIG. 9, in the bend-type phase shift circuit 20a of the present modification example the second ground conductor 44 is added as compared to the bend-type phase shift circuit 20a shown in FIG. 8. Since this second ground conductor 44 is provided, it is possible to reduce the amount of phase shift, compared to that in the bend-type phase shift circuit 20a shown in FIG. 8.

The second ground conductor 44 is a ground conductor formed in the same layer as the first ground conductor 43. The second ground conductor 44 is disposed on an outer bent side with respect to the pair of inner lines 42 in a plan view, and connects the other end portion of the first conductor 43a and the other end portion of the second conductor 43b included in the first ground conductor 43.

The second ground conductor 44 includes a fourth conductor 44a of which the other end portion is connected to the other end portion of the first conductor 43a included in the first ground conductor 43, and a fifth conductor 44b of which the other end portion is connected to the other end portion of the second conductor 43b included in the first ground conductor 43. In addition, the second ground conductor 44 includes a sixth conductor 44c connected to one end portion of the fourth conductor 44a and the fifth conductor 44b and having a surface shape that protrudes toward the signal line 41 and the pair of inner lines 42 in a plan view. One end portion of the fourth conductor 44a is connected to one end portion of the fifth conductor 44b via the sixth conductor 44c.

The fourth conductor 44a is a strip-shaped conductor extending in a direction along the signal line 1 of the digital phase shift circuit 10-6. The fifth conductor 44b is a strip-shaped conductor extending in the direction along the signal line 1 of the digital phase shift circuit 10-5. The fourth conductor 44a and the fifth conductor 44b are wider than the first conductor 43a and the second conductor 43b included in the first ground conductor 43. That is, the fourth conductor 44a and the fifth conductor 44b are disposed such that the extending directions thereof intersect (for example, are orthogonal to) each other, and are strip-shaped conductors that are wider than the first conductor 43a and the second conductor 43b included in the first ground conductor 43. Since the fourth conductor 44a and the fifth conductor 44b are widened, it is possible to reduce the inductance of the second ground conductor 44 as much as possible.

The sixth conductor 44c is a conductor connected to one end portion of the fourth conductor 44a and one end portion of the fifth conductor 44b and having a surface shape that protrudes toward the signal line 41 and the pair of inner lines 42 in a plan view. Similar to the case in which the third conductor 43c is provided in the first ground conductor 43 to reduce the inductance of the first ground conductor 43, since the sixth conductor 44c is provided in the second ground conductor 44, it is possible to reduce the amount of phase shift of the bend-type phase shift circuit 20a by reducing the inductance of the second ground conductor 44. The sixth conductor 44c shown in FIG. 9 has a rectangular shape in a plan view, but the sixth conductor 44c may have any shape in a plan view.

Here, when the protruding amount of the sixth conductor 44c increases, the inductance of the second ground conductor 44 can be reduced. However, as the sixth conductor 44c is closer to the signal line 41, the influence of the mutual inductance between the second ground conductor 44 and the signal line 41 increases. Therefore, it is desirable that the protruding amount of the sixth conductor 44c is set in view of the magnitude of the inductance of the second ground conductor 44 and the influence of the mutual inductance between the second ground conductor 44 and the signal line 41.

In the present modification example, the second ground conductor 44 is provided in addition to the first ground conductor 43. Therefore, a current corresponding to the return current R1 shown in FIG. 3 can be dispersed to flow through the first ground conductor 43 and the second ground conductor 44. In this manner, the amount of phase shift of the bend-type phase shift circuit 20a can be reduced.

### Fifth Modification Example

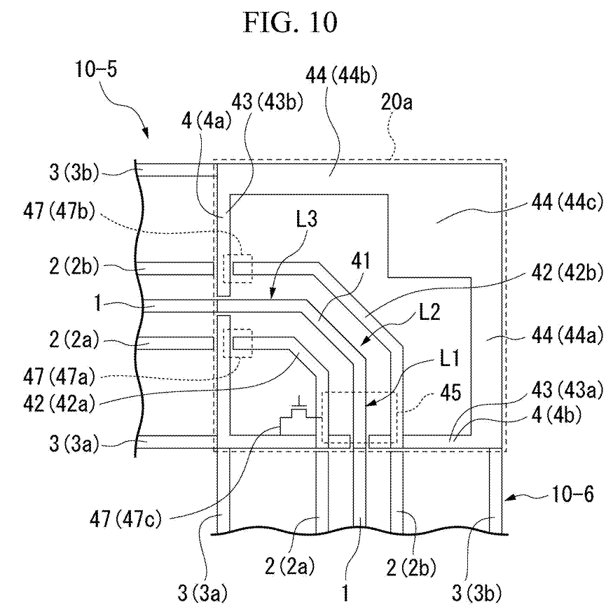

FIG. 10 is a plan view showing the configuration of a bend-type phase shift circuit according to a fifth modification example in the first embodiment of the present invention. As shown in FIG. 10, in the bend-type phase shift circuit 20a of the present modification example, the third conductor 43c included in the first ground conductor 43 is omitted as compared to the bend-type phase shift circuit 20a shown in FIG. 9. That is, it can be described that the bend-type phase shift circuit 20a of the present modification example is obtained by adding the second ground conductor 44 shown in FIG. 9 to the bend-type phase shift circuit 20a shown in FIG. 5.

In the present modification example, since the third conductor 43c is omitted, it is considered that the inductance of the first ground conductor 43 slightly increases. However, in the present modification example, since the second ground conductor 44 is provided in addition to the first ground conductor 43, for example, the amount of phase shift in the bend-type phase shift circuit 20a of the present modification example can be made smaller than that of the bend-type phase shift circuit 20a shown in FIG. 5.

### Sixth Modification Example

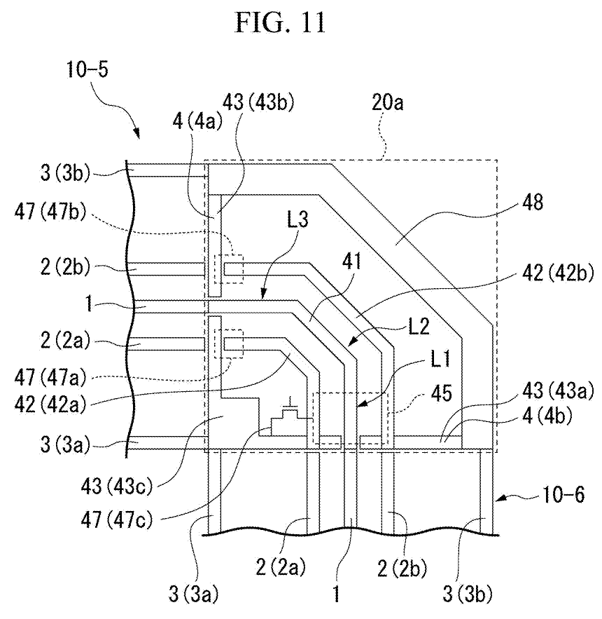

FIG. 11 is a plan view showing the configuration of a bend-type phase shift circuit according to a sixth modification example in the first embodiment of the present invention. As shown in FIG. 11, the bend-type phase shift circuit 20a of the present modification example is obtained by adding the outer line 48 to the bend-type phase shift circuit 20a shown in FIG. 8. Since this outer line 48 is provided, it is possible to align the amount of phase shift of the bend-type phase shift circuit 20a with the amount of phase shift of the digital phase shift circuit 10 such as the digital phase shift circuits 10-5 and 10-6.

The outer line 48 is a line formed in the same layer as the signal line 41 and the pair of inner lines 42, and for example, corresponds to the second outer line 3b shown in FIG. 2. The outer line 48 is formed to be wider than the signal line 41 and the pair of inner lines 42. The outer line 48 is disposed on an outer bent side with respect to the pair of inner lines 42, and is electrically connected to the other end portion of the first conductor 43a and the other end portion of the second conductor 43b included in the first ground conductor 43. The outer line 48 is electrically connected to the other end portion of the first conductor 43a and the other end portion of the second conductor 43b included in the first ground conductor 43 by the same connection conductor as the connection conductors 6e and 6f shown in FIG. 2.

In the bend-type phase shift circuit 20a of the present modification example, so to speak, the outer line 48 is provided instead of the second ground conductor 44 of the bend-type phase shift circuit 20a shown in FIG. 9. Therefore, a current corresponding to the return current R1 shown in FIG. 3 can be dispersed to flow through the first ground conductor 43 and the outer line 48. In addition, the inductance of the outer line 48 can be adjusted by adjusting the width of the outer line 48. In this manner, the amount of phase shift of the bend-type phase shift circuit 20a can be aligned with the amount of phase shift of the digital phase shift circuit 10 such as the digital phase shift circuits 10-5 and 10-6.

### Seventh Modification Example

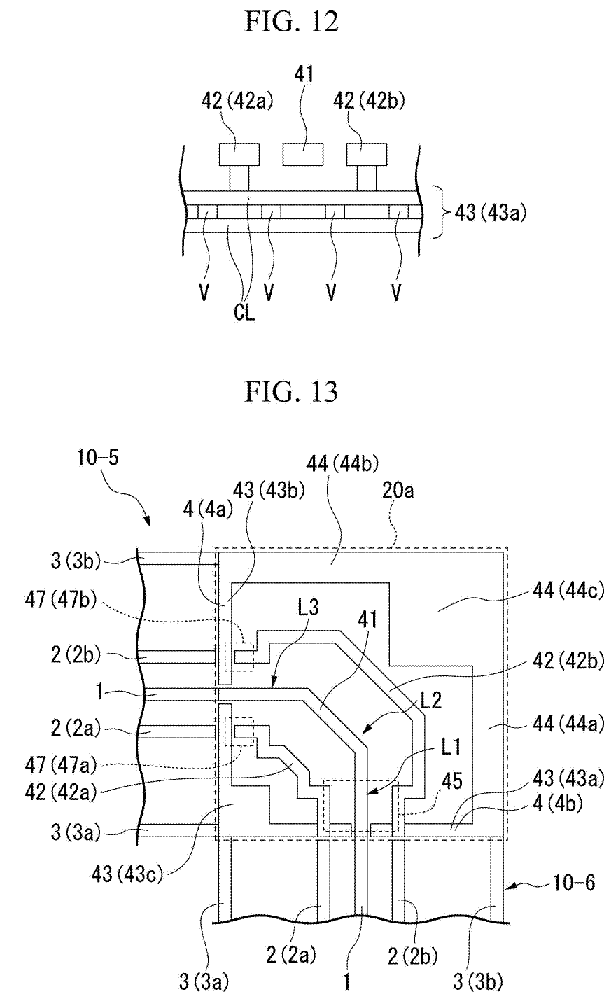

FIG. 12 is a cross-sectional view showing a part of the schematic configuration of a bend-type phase shift circuit according to a seventh modification example in the first embodiment of the present invention. FIG. 12 is a cross-sectional view taken along line A-A in FIG. 5. As shown in FIG. 12, in the bend-type phase shift circuit 20a of the present modification example, the first ground conductor 43 is formed by the electrically connected multilayer conductive layers CL.

In an example shown in FIG. 12, the first ground conductor 43 is formed by two conductive layers CL electrically connected by via holes V. The number of the conductive layers CL is not limited to two, and may be three or more. In this way, since the first ground conductor 43 is formed by the electrically connected multilayer conductive layers CL, it is possible to reduce a loss and the inductance of the first ground conductor 43. As in the first ground conductor 43, the second ground conductor 44 may be formed by the electrically connected multilayer conductive layers CL.

### Eighth Modification Example

FIG. 13 is a plan view showing the configuration of a bend-type phase shift circuit according to an eighth modification example in the first embodiment of the present invention. As shown in FIG. 13, in the bend-type phase shift circuit 20a of the present modification example, the pair of inner lines 42 are located further away from the signal line 41 as compared to the bend-type phase shift circuit 20a shown in FIG. 9. However, both ends of the pair of inner lines 42 need to face the pair of inner lines 2 of the digital phase shift circuits 10-6 and 10-5 respectively. Therefore, both ends of the pair of inner lines 42 are disposed at the same positions as those in the above-described embodiment and modification examples.

The first inner line 42a includes a first protruding portion extending from one end portion thereof toward the second conductor 43b of the first ground conductor 43 in a direction along the first conductor 43a of the first ground conductor 43, and a second protruding portion extending from the other end portion thereof toward the first conductor 43a of the first ground conductor 43 in a direction along the second conductor 43b of the first ground conductor 43. The first protruding portion is located in an intermediate portion of the first straight portion L1 of the first inner line 42a. That is, in the first straight portion L1 of the first inner line 42a, two portions are separated with the first protruding portion therebetween and connected by the first protruding portion. The second protruding portion is located in an intermediate portion of the third straight portion L3 of the first inner line 42a. That is, in the third straight portion L3 of the first inner line 42a, two portions are separated with the second protruding portion therebetween and connected by the second protruding portion.

The second inner line 42b includes a third protruding portion extending from one end portion thereof toward the fourth conductor 44a of the second ground conductor 44 in the direction along the first conductor 43a of the first ground conductor 43, and a fourth protruding portion extending from the other end portion thereof toward the fifth conductor 44b of the second ground conductor 44 in the direction along the second conductor 43b of the first ground conductor 43. The third protruding portion is located in an intermediate portion of the first straight portion L1 of the second inner line 42b. That is, in the first straight portion L1 of the second inner line 42b, two portions are separated with the third protruding portion therebetween and connected by the third protruding portion. The fourth protruding portion is located in an intermediate portion of the third straight portion L3 of the second inner line 42b. That is, in the third straight portion L3 of the second inner line 42b, two portions are separated with the fourth protruding portion therebetween and connected by the fourth protruding portion.

Since a part of the pair of inner lines 42 is located away from the signal line 41, the amount of phase shift of the bend-type phase shift circuit 20a can be reduced. How far the pair of inner lines 42 is located away from the signal line 41 is set in view of the amount of phase shift of the bend-type phase shift circuit 20a.

### SECOND EMBODIMENT

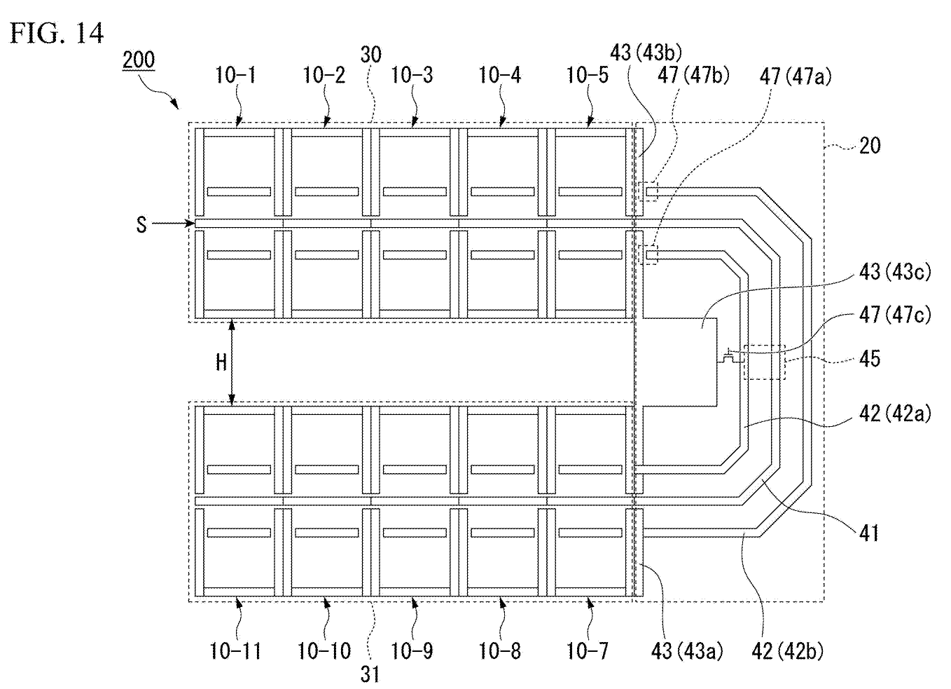

FIG. 14 is a plan view showing the schematic configuration of a digital phase shifter according to a second embodiment of the present invention. In FIG. 14, the same reference numerals are assigned to the configuration corresponding to the configurations shown in FIGS. 1-13. As shown in FIG. 14, a digital phase shifter 200 of the present embodiment has a configuration in which the bend-type phase shift circuit 20 is provided instead of the bend-type phase shift circuits 20a and 20b and the digital phase shift circuit 10-6 of the digital phase shifter 100 of the first embodiment.

Each of the bend-type phase shift circuits 20a and 20b of the digital phase shifter 100 of the first embodiment shown in FIG. 1 is a 90° bend-type phase shift circuit that realizes a function of bending the path of the signal S by 90° and a function as the phase shift circuit. In contrast, the bend-type phase shift circuit 20 of the digital phase shifter 200 of the present embodiment is a 180° bend-type phase shift circuit that realizes a function of bending the path of the signal S by 180° and a function as the phase shift circuit. The bend-type phase shift circuit 20 connects the digital phase shift circuit 10-5 (first digital phase shift circuit) located at one end portion of the first digital phase shift circuit group 30 and the digital phase shift circuit 10-7 (second digital phase shift circuit) located at one end portion of the second digital phase shift circuit group 31.

As in the bend-type phase shift circuit 20a shown in FIG. 8, the bend-type phase shift circuit 20 includes the signal line 41, the pair of inner lines 42 (first inner line 42a and second inner line 42b), the first ground conductor 43, the capacitor 45, and the three electronic switches 47 (first electronic switch 47a, second electronic switch 47b, and third electronic switch 47c).

Since the bend-type phase shift circuit 20a shown in FIG. 8 is a 90° bend-type phase shift circuit, the signal line 41 and the pair of inner lines 42 are bent in a substantially L-shape. In contrast, since the bend-type phase shift circuit 20 of the present embodiment is a 180° bend-type phase shift circuit, the signal line 41 and the pair of inner lines 42 are bent in a substantially U-shape.

In addition, since the bend-type phase shift circuit 20a shown in FIG. 8 is a 90° bend-type phase shift circuit, the first conductor 43a and the second conductor 43b of the first ground conductor 43 are disposed such that extending directions thereof are orthogonal to each other. In contrast, since the bend-type phase shift circuit 20 of the present embodiment is a 180° bend-type phase shift circuit, the first conductor 43a and the second conductor 43b of the first ground conductor 43 are disposed on a straight line.

The third conductor 43c of the first ground conductor 43 is provided to be in a state of protruding from one end portion of the first conductor 43a and one end portion of the second conductor 43b toward the center portion of the signal line 41 and the center portions of the pair of inner lines 42 which are bent in the substantially U-shape. In the bend-type phase shift circuit 20 of the present embodiment, the capacitor 45 and the third electronic switch 47c are provided at positions different from those where the capacitor 45 and the third electronic switch 47c are provided in the bend-type phase shift circuit 20a shown in FIG. 8. In the capacitor 45, the upper electrode thereof is electrically connected to the center portion of the signal line 41, and the lower electrode thereof is electrically connected to the third electronic switch 47c. The third electronic switch 47c is connected in series to the capacitor 45 between the center portion of the signal line 41 and the third conductor 43c of the first ground conductor 43.

As in the bend-type phase shift circuits 20a and 20b of the first embodiment, the bend-type phase shift circuit 20 of the present embodiment includes the signal line 41, the pair of inner lines 42 provided on both sides of the signal line 41, the first ground conductor 43 including the first conductor 43a electrically connected to one end of each of the pair of inner lines 42 and the second conductor 43b provided on the other end side of the pair of inner lines 42 and of which one end portion is connected to one end portion of the first conductor 43a, and the pair of electronic switches 47a and 47b respectively provided between each other end of the pair of inner lines 42 and the second conductor 43b. The signal line 41 and the pair of inner lines 42 are bent such that one end portion of the first conductor 43a and one end portion of the second conductor 43b included in the first ground conductor 43 are disposed on an inner bent side with respect to the signal line and the pair of inner lines, and the bend-type phase shift circuit 20 is set to the low-delay mode in which the pair of electronic switches 47a and 47b are in the closed state or to the high-delay mode in which the pair of electronic switches are in the open state. In this manner, the bend-type phase shift circuit 20 in which a function as the phase shift circuit is added to a function of bending the path of the signal S by 180° which is a function of the connection portion in the related art can be realized.

Since the bend-type phase shift circuit 20 has the function of bending the path of the signal S by 180° and the function as the phase shift circuit, even when the number of bending times of the digital phase shifter 200 increases, an occupied area of the portion that does not function as the phase shift circuit does not increase. As a result, the mounting area of the digital phase shifter can be decreased, compared to that in the related art.

In addition, the bend-type phase shift circuit 20 of the present embodiment has a configuration in which the capacitor 45 is located at the center portion of the signal line 41 in a plan view, and has a symmetrical configuration. In this manner, characteristics of the bend-type phase shift circuit 20 when viewed from the digital phase shift circuit 10-5 side and characteristics of the bend-type phase shift circuit 20 when viewed from the digital phase shift circuit 10-7 side can coincide with each other (or can have the same characteristics).

Also, a part of the configurations of the first embodiment shown in FIG. 5 and the first, second, and fourth to eighth modification examples of the first embodiment shown in FIGS. 6, 7 and 9-13, can also be applied to the bend-type phase shift circuit 20 of the present embodiment. For example, a part of the configuration of the fourth modification example of the first embodiment shown in FIG. 9 may be applied to the bend-type phase shift circuit 20 of the present embodiment to adopt a configuration in which the other end portion of the first conductor 43a and the other end portion of the second conductor 43b included in the first ground conductor 43 are connected by the second ground conductor 44. In addition, a part of the configuration of the sixth modification example of the first embodiment shown in FIG. 11 may be applied to the bend-type phase shift circuit 20 of the present embodiment to adopt a configuration in which the other end portion of the first conductor 43a and the other end portion of the second conductor 43b included in the first ground conductor 43 are electrically connected by the outer line 48.

In addition, a part of the configuration of the first modification example of the first embodiment shown in FIG. 6 may be applied to the bend-type phase shift circuit 20 of the present embodiment to adopt a configuration in which the capacitor 45 and the third electronic switch 47c are provided on the digital phase shift circuit 10-5 side and the digital phase shift circuit 10-7 side. Alternatively, a part of the configuration of the seventh modification example of the first embodiment shown in FIG. 12 may be applied to the bend-type phase shift circuit 20 of the present embodiment such that at least one of the first ground conductor 43 and the second ground conductor 44 is formed by the electrically connected multilayer conductive layers CL.

Although the embodiments of the present invention are described above, the above-described embodiments are only examples of the present invention and the present invention is not limited to the above-described embodiments, so additions, omissions, substitutions, and other modifications can be made within the scope of the present invention. Accordingly, the invention is not to be considered as being limited by the foregoing description and is only limited by the scope of the appended claims.

For example, the bend-type phase shift circuits 20a and 20b according to the first embodiment described above have the 90° bend shape, and the bend-type phase shift circuit 20 according to the second embodiment described above has the 180° bend shape. However, the bend-type phase shift circuit may have a shape other than the 90° bend shape and the 180° bend shape (for example, a 45° bend shape). When the bend-type phase shift circuit has the shape other than the 90° bend shape and the 180° bend shape, the first conductor 43a and the second conductor 43b of the first ground conductor 43 and the fourth conductor 44a and the fifth conductor 44b of the second ground conductor 44 are disposed such that the extending directions thereof intersect each other.

In addition, each of the bend-type phase shift circuits 20a and 20b according to the first embodiment described above and the bend-type phase shift circuit 20 according to the second embodiment described above includes the pair of inner lines 42 (first inner line 42a and second inner line 42b) provided on both sides of the signal line 41. However, the inner line 42 may be provided on only one side of the signal line 41. That is, a configuration in which only the first inner line 42a is provided may be adopted, or a configuration in which only the second inner line 42b is provided may be adopted.

In addition, the digital phase shifters 100 and 200 according to the first and second embodiments described above have the U-shape in a plan view. However, the digital phase shifter may have a shape other than the U-shape in a plan view (for example, a spiral shape or a meandering shape). The digital phase shifter having this shape is realized by connecting the plurality of digital phase shift circuit groups with the plurality of bend-type phase shift circuits.

### EXPLANATION OF REFERENCES

1 Signal line
2 Inner line
3 Outer line
4a First ground conductor
4b Second ground conductor
7a First electronic switch
7b Second electronic switch
10, 10-5, 10-6, 10-7 Digital phase shift circuit
20, 20a, 20b Bend-type phase shift circuit
30 First digital phase shift circuit group
31 Second digital phase shift circuit group
41 Signal line
42 Inner line
43 First ground conductor
43a First conductor
43b Second conductor
43c Third conductor
44 Second ground conductor
44a Fourth conductor
44b Fifth conductor
44c Sixth conductor
45 Capacitor
47a First electronic switch
47b Second electronic switch
48 Outer line
100, 200 Digital phase shifter
CL Conductive layer

What is claimed is:

1. A bend-type phase shift circuit comprising:
a signal line;
an inner line provided on at least one side of the signal line;
a first ground conductor including a first conductor electrically connected to one end of the inner line, and a second conductor which is provided on the other end side of the inner line and of which one end portion is connected to one end portion of the first conductor; and
an electronic switch provided between the other end of the inner line and the second conductor,
wherein the signal line and the inner line are bent such that the one end portion of the first conductor and the one end portion of the second conductor included in the first ground conductor are disposed on an inner bent side with respect to the signal line and the inner line, and
the bend-type phase shift circuit is set to a low-delay mode in which the electronic switch is in a closed state or to a high-delay mode in which the electronic switch is in an open state.

2. The bend-type phase shift circuit according to claim 1, further comprising:
a capacitor electrically connected between the signal line and at least one of the first conductor and the second conductor included in the first ground conductor.

3. The bend-type phase shift circuit according to claim 1,
wherein the first conductor and the second conductor included in the first ground conductor are strip-shaped conductors disposed such that extending directions thereof intersect each other.

4. The bend-type phase shift circuit according to claim 1,
wherein the one end portion of the first conductor and the one end portion of the second conductor included in the first ground conductor are in a state of protruding toward the signal line and the inner line in a plan view.

5. The bend-type phase shift circuit according to claim 1,
wherein the first ground conductor includes a third conductor connected to the one end portion of the first conductor and the one end portion of the second conductor and having a surface shape that protrudes toward the signal line and the inner line in a plan view.

6. The bend-type phase shift circuit according to claim 1, further comprising:
a second ground conductor disposed on an outer bent side with respect to the signal line and the inner line and connecting the other end portion of the first conductor and the other end portion of the second conductor included in the first ground conductor.

7. The bend-type phase shift circuit according to claim 6,
wherein the second ground conductor includes
a fourth conductor of which the other end portion is connected to the other end portion of the first conductor included in the first ground conductor, and
a fifth conductor of which the other end portion is connected to the other end portion of the second conductor included in the first ground conductor and one end portion is connected to one end portion of the fourth conductor.

8. The bend-type phase shift circuit according to claim 7,
wherein the fourth conductor and the fifth conductor included in the second ground conductor are strip-shaped conductors disposed such that extending directions thereof intersect each other, and having a larger width than the first conductor and the second conductor included in the first ground conductor.

9. The bend-type phase shift circuit according to claim 7,
wherein the second ground conductor includes a sixth conductor connected to the one end portion of the fourth conductor and the one end portion of the fifth conductor and having a surface shape that protrudes toward the signal line and the inner line in a plan view.

10. The bend-type phase shift circuit according to claim 1, further comprising:
an outer line disposed on an outer bent side with respect to the signal line and the inner line and electrically connected to the other end portion of the first conductor and the other end portion of the second conductor included in the first ground conductor.

11. The bend-type phase shift circuit according to claim 1,
wherein the first ground conductor is formed by electrically connected multilayer conductive layers.

12. The bend-type phase shift circuit according to claim 6,
wherein the second ground conductor is formed by electrically connected multilayer conductive layers.

13. A digital phase shifter comprising:
a first digital phase shift circuit group in which a plurality of digital phase shift circuits are cascade-connected;
a second digital phase shift circuit group in which a plurality of digital phase shift circuits are cascade-connected; and
the bend-type phase shift circuit according to claim 1, which is configured to electrically connect a first digital phase shift circuit located at one end portion of the first digital phase shift circuit group, and a second digital phase shift circuit located at one end portion of the second digital phase shift circuit group.

14. A digital phase shifter comprising:
a first digital phase shift circuit group in which a plurality of digital phase shift circuits are cascade-connected;
a second digital phase shift circuit group in which a plurality of digital phase shift circuits are cascade-connected;
a third digital phase shift circuit electrically connected to a first digital phase shift circuit located at one end portion of the first digital phase shift circuit group and a second digital phase shift circuit located at one end portion of the second digital phase shift circuit group;
a first bend-type phase shift circuit that is the bend-type phase shift circuit according to claim 1, which is configured to connect the first digital phase shift circuit and the third digital phase shift circuit; and
a second bend-type phase shift circuit that is the bend-type phase shift circuit according to claim 1, which is configured to connect the second digital phase shift circuit and the third digital phase shift circuit.

15. The digital phase shifter according to claim 13,
wherein each of the plurality of digital phase shift circuits forming the first digital phase shift circuit group and the plurality of digital phase shift circuits forming the second digital phase shift circuit group is a circuit that includes a signal line, a pair of inner lines provided on both sides of the signal line, a pair of outer lines provided on outer sides of the pair of inner lines, a first ground conductor electrically connected to one end of each of the pair of inner lines and the pair of outer lines, a second ground conductor electrically connected to the other end of each of the pair of outer lines, and a pair of electronic switches respectively provided between the other ends of the pair of inner lines and the second ground conductor, and that are set to a low-delay mode in which the pair of electronic switches are in a closed state or a high-delay mode in which the pair of electronic switches are in an open state.

16. The digital phase shifter according to claim 14,
wherein each of the plurality of digital phase shift circuits forming the first digital phase shift circuit group, the plurality of digital phase shift circuits forming the second digital phase shift circuit group, and the third digital phase shift circuit is a circuit that includes a signal line, a pair of inner lines provided on both sides of the signal line, a pair of outer lines provided on outer sides of the pair of inner lines, a first ground conductor electrically connected to one end of each of the pair of inner lines and the pair of outer lines, a second ground conductor electrically connected to the other end of each of the pair of outer lines, and a pair of electronic switches respectively provided between
the other ends of the pair of inner lines and the second ground conductor, and that are set to a low-delay mode in which the pair of electronic switches are in a closed state or a high-delay mode in which the pair of electronic switches are in an open state.
